(19) United States
(12) Patent Application Publication
(10) Pub. No.: US 2011/0136553 A1
(43) Pub. Date: Jun. 9, 2011

(54) PORTABLE ELECTRONIC PRODUCTS INTEGRATED WITH SILICONE

(76) Inventor: Cheol-Ho Jo, Namyangju (KR)

(21) Appl. No.: 12/862,239

(22) Filed: Aug. 24, 2010

(30) Foreign Application Priority Data
Dec. 8, 2009 (KR) 10-2009-0121348

(51) Int. Cl. H04M 1/00

(52) U.S. Cl. 455/575.3; 455/575.1

(57) ABSTRACT

Disclosed is a portable electronic products integrated with a silicone in which a molding silicone is integrated with an outer side surface of a body housing of the portable electronic products through a double injection or an insert injection molding methods, so that it can feel the soft grip when an user is touched on the outer surface of the portable electronic products. Also, a water proof injection silicone packing part is integrally formed at a combining portion between a cover housing and a body housing, so that it can closely adhere to them, whereby it can be perfectly cut off the moisture from outside.

### BACKGROUND OF THE INVENTION

1. Field of the Invention

The present invention relates to a portable electronic products integrated with a silicone, and more particularly to a portable electronic products integrated with a silicone in which a molding silicone is integrated with an outer side surface of a body housing of the portable electronic products through a double injection or an insert injection molding methods, so that it can feel the soft grip when an user is touched on the outer surface of the portable electronic products, and a water proof injection silicone packing part is integrally formed at a combining portion between a cover housing and a body housing, so that it can closely adhere to them, whereby it can be perfectly cut off the moisture from outside.

2. Description of the Prior Art

Generally, a communication terminal can be classified into wire/wireless communication terminals. In the wire communication terminal, official or domestic telephones are representative. In the wireless communication terminal, a PCS, a cellular phone or a PDA are representative. Generally, since the wireless communication terminal offers portability to user, it is named as a mobile communication terminal or a portable terminal (hereinafter, a cellular phone).

Such a cellular phone offers not only a simple voice information but also a character information, an image information, a game to user. Also, these cellular phones can divide into a bar type, a flip type, a folder type, and a slide type and so on.

However, since the material of a body housing, which forms an external appearance of the conventional cellular phone, is polycarbonate (PC) or polypropylene (PP) plastic materials, it feels hard when the user is touched on the outer surface of the cellular phone, thereby deteriorating the texture thereof.

Moreover, in the conventional cellular phone, in order to cut off the moisture from outside, the separate waterproof ring is inserted into a combining portion between a cover housing and a body housing. However, there is a problem in that the cost of production is sharply increased due to the separate manufacturing and assembly of the waterproof ring.

### SUMMARY OF THE INVENTION

Accordingly, the present invention has been made to solve the above-mentioned problems occurring in the prior art, and an object of the present invention is to provide a portable electronic products integrated with a silicone in which a molding silicone is integrated with an outer side surface of a body housing of the portable electronic products through a double injection or an insert injection molding methods, so that it can feel the soft grip when an user is touched on the outer surface of the portable electronic products, thereby feeling good to the touch.

Another object of the present invention is to provide a portable electronic products integrated with a silicone in which a water proof injection silicone packing part is integrally formed at a combining portion between a cover housing and a body housing, so that it can closely adhere to them, whereby it can be perfectly cut off the moisture from outside. Accordingly, since it is not necessary to manufacture the separate waterproof ring as in the conventional art, it can remarkably reduce the cost of production and prevent a poor assembly.

In accordance with an aspect of the present invention, there is provided a portable electronic products integrated with a silicone having a body housing and a cover housing for covering the body housing comprising an integrated injection silicone integrally formed on the entire outer side surface of the body housing through a silicone injection molding.

Preferably, the integrated injection silicone is formed at the outer side surface of the body housing, which is made of any one selected from a polycarbonate (PC), a PC/ABS, a PC-GF (Glass Fiber), a polyamine (PA), and a polypropylene (PP), through a double injection or an insert injection molding methods of a soft silicone material (Liquid Silicone Rubber).

Preferably, a water proof injection silicone packing part integrally extended from the integrated injection silicone is formed at a combining portion of the cover housing and the body housing.

Preferably, the portable electronic products is any one selected from a bar type cellular phone, a folder type cellular phone, and a slide type cellular phone.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a portable electronic products integrated with a silicone according to the present invention;

FIG. 2 is a partially cut perspective view of a portable electronic products integrated with a silicone according to the present invention; and

FIG. 3A and FIG. 3B are sectional views illustrating open and closed states of a portable electronic products integrated with a silicone according to another embodiment of the present invention respectively.

### DETAILED DESCRIPTION OF THE EXEMPLARY EMBODIMENTS

Hereinafter, preferred embodiments of the present invention will be described with reference to the accompanying drawings.

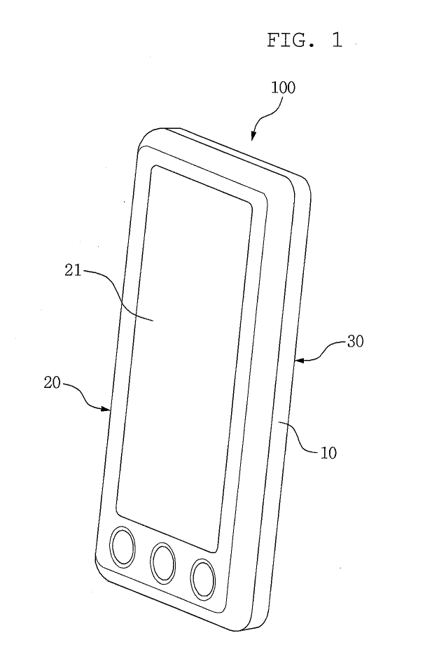

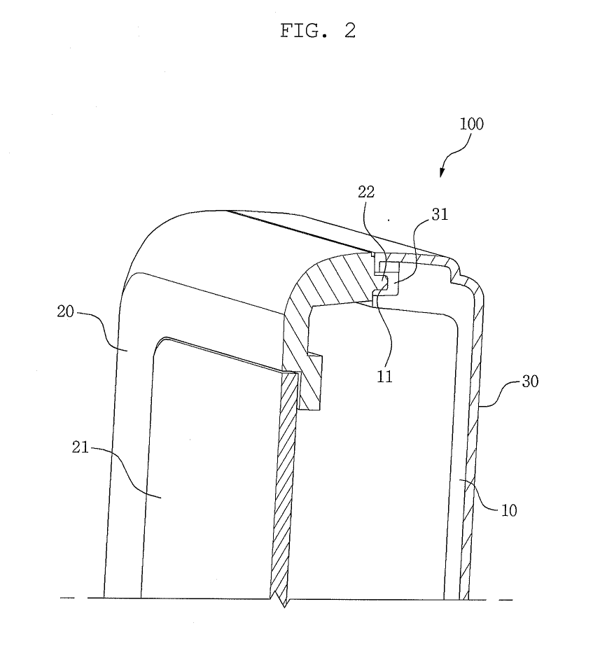

FIG. 1 is a perspective view of a portable electronic products integrated with a silicone according to the present invention and FIG. 2 is a partially cut perspective view of a portable electronic products integrated with a silicone according to the present invention.

As shown in the drawings, the portable electronic products 100 integrated with the silicone according to one embodiment of the present invention, which is a cellular phone of a bar type, elementarily includes a body housing 10 and a cover housing 20.

The body housing 10 and the cover housing 20 assume the form of rectangular, in which the length thereof is relatively longer than the width thereof. Also, a combining groove 11 and a combining projection 22 are formed at the body housing 10 and the cover housing 20 respectively along the edges thereof and are inserted to each other to be jointed.

Here, as described in below, a water proof injection silicone packing part 31 is formed between the combining groove 11 and the combining projection 22, thereby it can perform a role of the waterproofing.

In the center of the above-described cover housing 20, a display unit 21 for accomplishing a touch screen of a big rectangular shape is generally formed. By means of such a touch manner, the various functions such as an image movie, a file viewer, a GPS, a mobile disk, a smart phone, an electronic dictionary, a multitasking, a MP3, a bluetooth, a recognition of movement, a translator etc. can be utilized. Since these technical features are widely well-known, further detailed explanations are omitted here.

As described above, the cover housing 20 includes the combining projection 22 formed along the edge thereof and inserted into the combining groove 11 formed along the edge of the housing 10.

Here, an integrated injection (molding) silicone 30 is formed on the entire outer side surface (lower surface) of the body housing 10 through an injection molding of a soft silicone material so as to cover the external appearance of the body housing with the integrated injection silicone 30.

During injection manufacturing of the body housing 10, which is made of a well-known polycarbonate (PC), PC/ABS, PC-GF (Glass Fiber), polyamine (PA) or polypropylene (PP) etc., the integrated injection (molding) silicone 30 can be integrally attached to and formed at the entire outer side surface (lower surface) of the body housing 10 through the double injection or the insert injection molding method of a soft silicone material (Liquid Silicone Rubber).

Also, the water proof injection silicone packing part 31, which is formed on the combining groove 11 of the body housing 10, can be integrally extended and formed from the integrated injection silicone 30.

Here, the above-described silicone is called as a polysiloxane and is a chemical polymer having a silicone atom, which is in the form of a fluid, a resin or an elastomer. Usually, in the silicone, the organic group of two methyl (—CH3) or a phenyl (—C6H5) usually sticks to each silicone atom.

Especially, the silicone has the advantage that the hardness and flexibility are excellent. In addition, since it is still better than a urethane or an elastomer in terms of a texture, it can feel the soft grip when the user is touched on the outer surface of the portable electronic products in comparison with the urethane or the elastomer.

Moreover, since the silicone has an excellent watertight, the water proof injection silicone packing part 31 molded on the combining groove 11 of the body housing 10 allows the combining portion between the cover housing and the body housing to be closely adhered, thereby perfectly cutting off the moisture from outside.

Here, the portable electronic products 100 integrated with the silicone according to the present invention is not limited to a general cellular phone capable of mobile communication.

That is, the portable electronic products 100 integrated with the silicone according to the present invention can be identically applied to portable electricity electronic devices such as a PDA (Personal Digital Assistant), a smart phone, a hand held PC, a MP3/MP4 player, a game console, a notebook etc or other all portable electronic products.

Moreover, this portable electricity electronic device is provided with a predetermined communications module such as a CDMA (Code Division Multiplexing Access) module, a bluetooth module, an infrared data association (IrDA), or wireless and wired RAN card. Also, it can be provided a predetermined microprocessor for performing a multimedia playback function such as game items etc.

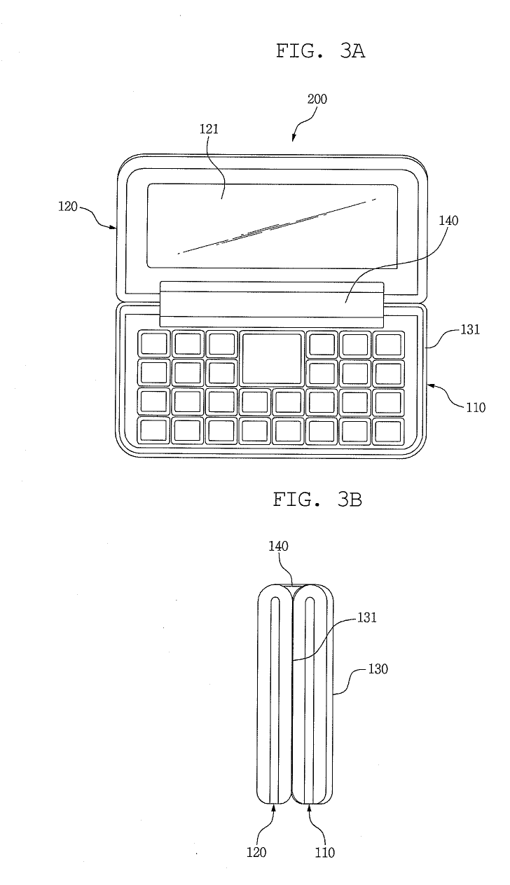

FIG. 3A and FIG. 3B are sectional views illustrating open and closed states of a portable electronic products integrated with a silicone according to another embodiment of the present invention respectively. A body housing 110 and a cover housing 120 of FIG. 3A and FIG. 3B are different from those of FIG. 1 and FIG. 2 in terms of up and down opening and closing manner, that is, folder-type opening and closing manner.

That is, as shown in FIG. 3A and FIG. 3B, the portable electronic products 200 integrated with the silicone according to another embodiment of the present invention basically includes a body housing 110 and a cover housing 120.

Here, a general cellular phone using up and down opening and closing mode (in the relevant industry, it is called as a “folder-type”) in which the cover housing 120 revolves about the body housing 110 upward and downward can be given as one example.

The cover housing 120 can vertically revolve about the body housing 110 in the direction of the width thereof through a well-known hinge apparatus 140.

In this case, the body housing 110 includes a keypad. Preferably, the kind of the keypad is a querty type keypad having a keyboard layout capable of inputting an alphabet and another language.

In the center of the above-described cover housing 120, a display unit 121 for accomplishing a touch screen of a big rectangular shape is generally formed. By means of such a touch manner, the various functions such as an image movie, a file viewer, a GPS, a mobile disk, a smart phone, an electronic dictionary, a multitasking, a MP3, a bluetooth, a recognition of movement, a translator etc. can be utilized. Since these technical features are widely well-known, further detailed explanations are omitted here.

In the meantime, an integrated injection (molding) silicone 130 is formed on the entire outer side surface (lower surface) of the body housing 110 through an injection molding of a soft silicone material so as to cover the external appearance of the body housing with the integrated injection silicone 130.

That is, during injection manufacturing of the body housing 110, which is made of a polycarbonate (PC) or a polypropylene (PP) etc., the integrated injection (molding) silicone 130 can be integrally attached to and formed at the entire outer side surface (lower surface) of the body housing 110 through the double injection or the insert injection molding method of a soft silicone material (Liquid Silicone Rubber).

Also, the water proof injection silicone packing part 131, which is formed on the combining groove 11 of the body housing 110, can be integrally extended and formed from the integrated injection silicone 130.

Accordingly, the integrated molding silicone 130 and the water proof injection silicone packing part 131 are integrally formed at the lower surface and the edge of the upper surface of the body housing 110, so that it can feel the soft grip when an user is touched on the outer surface (lower surface) of the body housing 110, and the water proof injection silicone packing part 131 can closely adhere to the combining portion (edge portion) between the cover housing 120 and the body housing 110, whereby it can be perfectly cut off the moisture from outside.

In the meantime, in the illustrated example, the cellular phone of bar type or folder type is illustrated. However, the integrated injection silicone according to the present invention can be applied to a slide-type cellular phone, in which the cover housing is slidably moved to the body housing in the longitudinal direction of the cellular phone to be opened and closed.

Although the present invention has been described with reference to Examples and Test Examples, those skilled in the art will appreciate that various modifications, additions and substitutions are possible, without departing from the scope and spirit of the invention as disclosed in the accompanying claims.

1. A portable electronic products integrated with a silicone having a body housing and a cover housing for covering the body housing comprising:
an integrated injection silicone integrally formed on the entire outer side surface of the body housing through a silicone injection molding.

2. The portable electronic products integrated with a silicone as claimed in claim 1, wherein the integrated injection silicone is formed at the outer side surface of the body housing, which is made of any one selected from a polycarbonate (PC), a PC/ABS, a PC-GF (Glass Fiber), a polyamine (PA), and a polypropylene (PP), through a double injection or an insert injection molding methods of a soft silicone material (Liquid Silicone Rubber).

3. The portable electronic products integrated with a silicone as claimed in claim 1, wherein a water proof injection silicone packing part integrally extended from the integrated injection silicone is formed at a combining portion between the cover housing and the body housing.

4. The portable electronic products integrated with a silicone as claimed in claim 1, wherein the portable electronic products is any one selected from a bar type cellular phone, a folder type cellular phone, and a slide type cellular phone.
